(19) United States
(12) Patent Application Publication
(10) Pub. No.: US 2015/0347112 A1
(43) Pub. Date: Dec. 3, 2015

(54) PROVIDING DATA ANALYTICS FOR COHORTS

(71) Applicant: Apple Inc., Cupertino, CA (US)

(72) Inventors: Trystan P. Kosmynka, San Jose, CA (US); Darren Ming Lew, Sunnyvale, CA (US)

(21) Appl. No.: 14/560,597

(22) Filed: Dec. 4, 2014

Related U.S. Application Data
(60) Provisional application No. 62/004,759, filed on May 29, 2014.

(51) Int. Cl. G06F 9/445; G06Q 30/02

(52) U.S. Cl. CPC G06F 8/61; G06Q 30/0201; G06F 8/62

(57) ABSTRACT

Systems, methods, and computer-readable storage media for providing data analytics for cohorts. A system sends, to a server such as an online store, a request to install on the system an application from the server. The system then receives a cohort string associated with the application and installs the cohort string on the system, the cohort string being linked to, or associated with, the application on the system. Next, the system detects a user of the application and based on the use of the application, the system collects analytics data about the use of the application at the system. The system then sends the cohort string and analytics data to a data analytics service.

### RELATED APPLICATIONS

This application claims priority to U.S. Provisional Patent Application No. 62/004,759, filed on May 29, 2014, entitled “PROVIDING DATA ANALYTICS FOR COHORTS,” the content of which is incorporated herein by reference in its entirety.

### TECHNICAL FIELD

The present technology pertains to data analytics, and more specifically pertains to collecting data analytics for application cohorts.

### BACKGROUND

Software and networking capabilities have been integrated with remarkable regularity in a score of common, everyday mobile devices such as mobile phones and tablet computers. Not surprisingly, the increasing capabilities of these devices have prompted an enormous demand for software applications. The Internet has further fueled this widespread demand by serving as a convenient resource for applications and greatly expanding the amount of applications available to users at their mobile devices. As a result, numerous applications, including local and online applications, have emerged to meet this demand for applications and allow users to perform a wide variety of functions, such as gaming, business, and social networking, conveniently from their mobile devices. Typically, users will download and purchase applications on their devices, and maintain a large number of applications in order to expand the functionality of their devices.

The demand for software applications has further created increasing incentives for developers and advertisers to monitor the performance of their applications, to better understand how their products are being used and can be improved. This information allows developers and advertisers to target their products to the proper audience, lure new customers to grow their customer base, and optimize their products in parallel with customer needs and demands. To this end, developers and advertisers often collect performance metrics and statistics for their applications, and study this information to extract meaningful patterns through data analytics.

The insight obtained through data analytics can be very valuable to developers and advertisers, as it can significantly grow their financial returns and further their brand by allowing developers and advertisers to optimize their products and campaigns. Unfortunately, however, current solutions for data analytics are largely inefficient and inconvenient for the user and developer. Moreover, current solutions are poorly integrated and significantly limited by compartmentalized implementations.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to efficiently perform data analytics for applications in a convenient manner for the user and developer. Precisely, these approaches provide automated and integrated solutions for data analytics. Here, cohort information can be generated automatically when a user initiates an application install, and the cohort information can be automatically integrated into the user's device with the application install. Consequently, the cohort information can be part of the install process, which can be implemented to plant applicable data on the device without a particular software development kit (SDK). The cohort information can then be used to collect and report analytics data for the cohort, in order to tie usage behavior with store events. Developers can conveniently obtain analytics data for particular cohorts in order to gain useful insights into the usage and performance of their application.

Advantageously, the cohort information can persist on storage even after a removal of the application associated with the cohort information, such that the cohort information can be retrieved during an application update or re-install and linked to the application. The cohort information can also provide a mechanism to track user behavior while protecting the user's privacy. For example, instead of using personal information to track the user and determine the user's behavior, cohort information can be used to represent the particular user and track his or her behavior, without specifically revealing or even collecting the user's private information.

Disclosed are systems, methods, and computer-readable storage media for data analytics of cohorts. A system can send, to an online store, a request to install on the system an application from the online store. Thereafter, the system can receive cohort information associated with the application. The cohort information can be, for example, a cohort string, a cohort identifier, cohort data, or any other form of data for identifying a cohort associated with the system or the user. Moreover, the cohort information can allow the system and any other user or device, such as a remote analytics server, to identify one or more cohorts associated with the installation of the application, the user, the user account, and/or the system itself. A cohort can refer to a group, segment, class, or category of users having one or more common characteristics, attributes, dimensions, behaviors, activities, actions, relationships, or any other similarities.

Next, the system can install the cohort information and link the cohort information to the application on the system. Based on a detection of a use of the application at the system, the system can then collect analytics data about the use of the application at the system and send the cohort information and analytics data to a data analytics service. The data analytics service can then present the analytics data on an interface for a user, such as a developer, to review and analyze the analytics data. The cohort information can allow the system as well as the data analytics service to organize or group users by a dimension, such as a specific characteristic or relationship, and create a cohort of users. With the cohort information, the system and data analytics service can identify specific behavioral patterns and characteristics for the cohort, and tie this information to store and transaction events in order to help a developer understand the behavior of the cohort of users vis-à-vis the application.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example configuration of devices and a network;

FIG. 2 illustrates an example system for performing data analytics for a cohort with a cohort service;

FIG. 3 illustrates an example cohort string;

FIG. 4 illustrates an example system for performing data analytics for a cohort without a cohort service;

FIG. 5 illustrates an example flowchart for performing data analytics according to some aspects of the subject technology; and

FIG. 6A and FIG. 6B illustrate example system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for convenient and efficient data analytics of cohorts. Disclosed are systems, methods, and non-transitory computer-readable storage media for performing data analytics for cohorts. In general, the approaches herein provide efficient and convenient implementations for collecting data analytics of cohorts associated with applications. To this end, cohort information can be generated and installed on client devices automatically as part of the installation of an application on the device. The cohort information can be generated in response to a message to a server, such as an online store, requesting to install the application on the device. The cohort information can then be used in collecting data analytics on the device, without having to install special software or an SDK on the device to provide such data analytics and cohorts functionality.

For example, a system can first send, to a server such as an online store, a request to install on the system an application from the online store. Thereafter, the system can receive cohort information associated with the application. The cohort information can be, for example, a cohort string, a cohort identifier, cohort data, etc. Moreover, the cohort information can allow the system and any other user or device, such as a remote analytics server, identify one or more cohorts associated with the installation of the application, the user, the user account, and/or the system itself.

Next, the system can install the cohort information and link the cohort information to the application on the system. Based on a detection of a use of the application at the system, the system can then collect analytics data about the use of the application at the system and send the cohort information and analytics data to a data analytics service. The data analytics service can then present the analytics data on an interface for a user, such as a developer, to review and analyze the analytics data. The cohort information can allow the system as well as the data analytics service to bucket or group users by a dimension, such as a specific characteristic or relationship, and create a cohort of users. With the cohort information, the system and data analytics service can identify specific behavioral patterns and characteristics for the cohort, and tie this information to store and transaction events in order to help a developer understand the behavior of the cohort of users vis-à-vis the application.

The data analytics service can be provided by a server configured to collect the cohort and analytics information, and generate presentations or views of that information in an interface. A developer can then access the interface, such as by login into a web page, to review the information. In some cases, the data analytics service can be hosted on a server(s) that is separate from the server(s) which hosts the online store. However, in other cases, the data analytics service can be hosted on the same server as the online store.

Moreover, the cohort information can be generated by the online store and sent to the system as part of the purchase or download event. However, in some configurations, the cohort information can be generated by a cohort service configured to generate cohort information as part of an application install process. This can be advantageous in cases where the cohort information contains additional information that may require additional processing and time to generate, in order to shift the load away from the online store and onto a cohort service that is separate from the online store. In this case, the cohort service can generate the cohort information and subsequently provide it to the system for installation at the system. Thus, in some cases, where the generation of cohort information requires additional processing which may delay the install process, the online store can move forward with the install process while the cohort service generates the cohort information.

The system can then communicate with the cohort service at one or more times or intervals to obtain the cohort information separately at a later time. For example, the cohort service can send the cohort information automatically after an event or a schedule or, alternatively, the system can fetch the cohort information from the cohort service as needed.

In other embodiments, the cohort service can be in communication with the online store to generate the cohort information and send the generated cohort information to the online store to be forwarded to the system as part of the install process. For example, the online store can receive a request to install or purchase an application and subsequently send a message to the cohort service to trigger the cohort service to generate the cohort information. The message from the online store to the cohort service can include information such as application information, user information, installation information, device information, online store information, etc., which can be used by the cohort service to generate the cohort information.

As previously mentioned, the system can receive the cohort information from the online store after initiating an installation or a purchase of the application through the online store. Here, the online store can generate the cohort information itself based on, for example, the purchase transaction, the purchase request message from the system, information extracted from a URL received from the system, a user account, system information, context information, and/or any other information associated with the transaction between the system and the online store. The online store can then persist or store the cohort information in a database, such as a transaction or finance database, and/or another database, such as a key/value store. Next, the online store can retrieve the cohort information from the database or the key/value store and forward the cohort information to the system as part of the installation of the application.

In some cases, the online store can retrieve the cohort information from the key/value store for faster access and improved performance. Further, the online store can persist the cohort information in one or more databases to allow the system or any other client or server device, including the online store, to access the cohort information in the future. For example, if the system un-installs the application and later initiates a re-installation of the application, the system can obtain the cohort information by fetching it from one or more databases associated with the online store. Similarly, if the system performs an application update, the system and the online store can access the cohort information from the original installation from the one or more databases storing the cohort information. As another example, if the system performs an in-app purchase within a parent application, the online store can retrieve the cohort information from the parent application, which persists in the one or more databases, and use the parent cohort information to generate the cohort information for the in-app purchase.

When installing the cohort information and the application, the system can link or associate the cohort information to the application for future reference. In some cases, the system can install the cohort information as part of the operating system on the system. However, in other cases, the system can install the cohort information as part of the actual application. In still other cases, the system can install the cohort information as part of both the operating system and the application. For example, the system can store various instances of the cohort information on the system, such as one instance of the cohort information on kernel space and another instance on user application space. Moreover, the installation of the cohort information can ensure that the cohort information persists on the system.

In some cases, the cohort information can be stored by the system such that it persists even after the application is removed. Thus, if the application is removed and later re-installed, the cohort information can remain on the system and can later be associated or linked with the application when it is re-installed on the system. However, in other cases, on re-downloads, the cohort information can be replaced with newly-generated cohort information specific to that re-download. The newly-generated cohort information can include store and user events specific to the re-download. Though in still other cases, the newly-generated cohort information can maintain information from the previous cohort information, such as the original purchase date, for example. To this end, the cohort information maintained at the system can include relevant cohort information from one or more previous installations, as well as the current installation. Similarly, on updates, the cohort information can be updated to include newly-generated cohort information from the update. For example, when a specific application is updated, the cohort information can be overwritten with new cohort information, which can include updated characteristics, such as a new install date.

In some embodiments, the cohort information can include an install date, a referrer identifier, a purchase date, and/or a campaign identifier. Here, the system can then collect analytics data and group or categorize the analytics data by install date, referrer, purchase date, and/or campaign. This way, a developer can obtain an insight on the performance of his or her application with respect to users having a particular install date, referrer, purchase date, and/or campaign, for example. In other embodiments, the cohort information can also include any other additional information, such as device data, user data, online store data, application data, installation details, purchase details, etc.

In the case of an in-app purchase from an application which already has cohort information associated with it, the purchase request can include cohort information or attributes right in the purchase or download parameters, which can be persisted along with a purchase record on the online store. Thus, the cohort information for an in-app purchase can include cohort information from the parent application so the in-app transaction is tied to the parent application's cohort information.

The cohort information can also include any cohort attributes or information in addition to those described above. Moreover, the cohort information can be generated in one or more types or formats. For example, in some cases, the cohort information can be a string, metadata, symbols, identifiers, media content and items, data items, or any other types of values and formats of information. For example, in some embodiments, the system can receive the cohort information from the online store as install metadata with the application.

Furthermore, the cohort information can be implemented according to a roll-out scheme. For example, an application that was previously purchased or downloaded and did not have any cohort information generated as part of the installation process may not have a full record of cohort information on the system or the online store. In such cases, if the application is later updated, re-downloaded, or otherwise involved in a transaction, such as an in-app purchase, the online store can obtain or generate a set of cohort information to create at least some record of cohort information for the application. For example, the finance server associated with the online store can generate a set of cohort information from whatever information or receipt is available based on the original transaction. Here, the online store can obtain cohort information indicating the original purchase date of the application, and send that cohort information to the system as part of the current install event. As the application is later updated or re-downloaded, the update or re-download can trigger the cohort information to be replaced or supplemented with new cohort data generated at that time, such as a new install date, for example.

In some embodiments, a cohort service can be implemented to generate cohort information in scenarios where no cohort information was previously created or installed at the time of the original application installation, as described in the example above. Here, the cohort service can analyze and retrieve as much information about the original—and any subsequent—transaction as it finds, and use that information to generate cohort information for the application, containing any attributes available. The cohort service can generate additional cohort information as new events take place and later send the information to the system or update the information currently on the system. The system can also query the cohort service at one or more intervals to fetch any cohort updates or new cohort information.

The data analytics collection process can be triggered by a use of the application on the system. For example, when a user launches or executes the application on the system, a data analytics service on the system can begin collecting data analytics based on the usage or activity of the application. Thus, the data analytics service can monitor activity of the user and application while the application is running, and collect relevant information to obtain analytics data. The system can then report the analytics data to one or more devices, such as a server running a data analytics service. For example, the data analytics service can obtain data analytics from one or more devices identifying those users that conducted a search in the online store, and report a percentage of those users who purchased application “X” from the search page. Indeed, the data analytics service can report more granular details, such as what percentages of those users who purchased application “X” from the search page launched the application after various periods of time, such as a day, a week, two weeks, a month, and so forth.

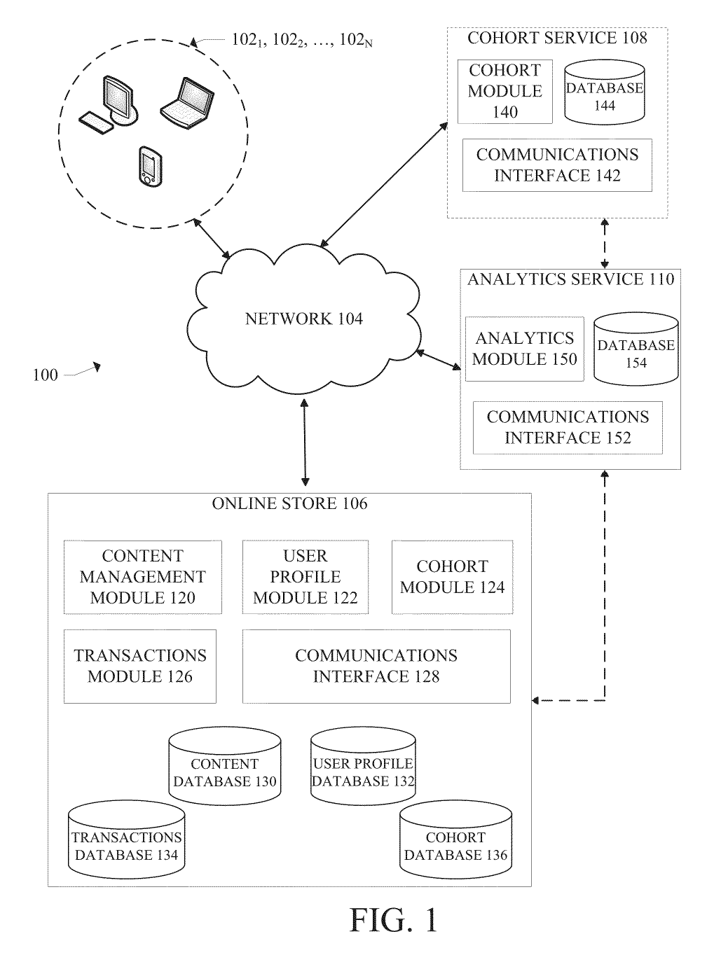

Having provided an introductory description of data analytics and cohorts, the disclosure now turns to FIG. 1, which illustrates an example system configuration 100, where electronic devices communicate via a network for purposes of exchanging content and other data. The system can be configured for use on a network, as illustrated in FIG. 1. The network can be, for example, a wide area network, a local area network, a private network, a virtual network, and so forth. Indeed, the present principles are applicable to a wide variety of network configurations that facilitate the intercommunication of electronic devices. For example, each of the components of system 100 in FIG. 1 can be implemented in a localized or distributed fashion in a network.

In system 100, software applications (Apps), metadata, cohort information, media content, and any other type of content and data can be delivered to user terminals 102₁, 102₂, . . . , 102ₙ, (collectively “102”) connected to a network 104 by direct and/or indirect communications with online store 106, which can run on a remote server or system. User terminals 102 can be any network enabled client devices, such as desktop computers; mobile computers; handheld communications devices (e.g., mobile phones, smart phones, tablet computers), smart televisions, set-top boxes, gaming systems, and/or any other network enabled computing devices. Furthermore, online store 106 can concurrently accept connections from, and interact with, multiple user terminals 102.

The online store 106 can receive a request for electronic content, such as a web page, an application, a media item, install preferences, metadata, etc., from one of user terminals 102. Thereafter, the online store 106 can retrieve the requested content, such as an application (App), and transmit the content to the requesting one of user terminals 102. To facilitate communications with the user terminals 102 and/or any other device or component, the online store 106 can include a communications interface 128.

The online store 106 can include a content management module 120 to facilitate the generation, assembly, selection, and delivery of a content package, such as an App and install metadata. The content management module 120 can gather data from the user terminals 102 and/or the cohort service system 108 and combine the content to generate a content package for the user terminals 102. For example, in the case of an App being delivered to a requesting one of user terminals 102, the content management module 120 can retrieve the App from the content database 130 and obtain cohort information from the cohort database 136 or the cohort service system 108, and deliver a content package, including the App and cohort information, to the user terminals 102 via the communications interface 128 and network 104.

Additionally, the content management module 120 can receive new content packages, such as applications, from separate developers and store the new Apps in the content database 130. Also, the content management module 120 can receive content updates, such as App updates or patches, for versions of content already stored on the content database 130, and update the content based on the updates. The content packages from the online store 106 can also include other data generated at the online store 106 or the user terminals 102, such as a content identifier, a store identifier, a distributor identifier, a developer identifier, install metadata, purchase data, preferences (e.g., plists, install files, library files, and so forth), a device identifier, a timestamp, an install date and time, installation instructions, installation data, App metadata, a content version identifier, a campaign identifier, a referrer identifier, user profile information, user characteristics, a user context, user activity, user preferences, etc.

Moreover, the content packages from the online store 106 can include cohort information, such as a cohort string, cohort data, or a cohort identifier, generated from the cohort service system 108 or the cohort module 124. For example, the cohort module 124 on the online store 106 can request cohort information from the cohort service system 108 or generate the cohort information based on data stored on the transactions database 134, to include as part of a content package. The cohort module 124 can request or generate the cohort information automatically as part of an installation process or upon receiving an installation request from one of the user terminals 102.

In some embodiments, the cohort module 140 on the cohort service system 108 can receive the request, command, or message from the online store 106 and generate cohort information to be transmitted to the online store 106 and/or one of the user terminals 102. The cohort module 140 can generate the cohort information based on content and information contained in the request, command, or message received from the online store 106 and/or information determined or generated at the cohort service system 108. For example, the online store 106 can transmit a cohort request to the cohort service system 108, and include in the request details about the time or date of the installation, the relevant campaign, the referrer of the content requested by the user terminal 102ᵢ, online store information, App information, etc. As previously mentioned, the cohort module 140 can also collect or generate additional information to include in the cohort information. For example, the message from the online store 106 may include a referrer identifier and a campaign identifier, but fail to include a timestamp associated with the install. In some cases, the cohort module 140 can then create cohort information based on the information received in the message from the online store, viz., the referrer and campaign identifiers, and further include a timestamp generated at the cohort service system 108 to represent a time and/or date of the installation.

The cohort service system 108 can include a cohort data database 144 for storing cohort information, as well as information received from the online store 106 to generate the cohort information and any information generated or obtained by the cohort module 140 for inclusion in the cohort information transmitted to the online store 106 and/or the relevant user terminal 102ᵢ. The cohort service system 108 can communicate the cohort information to the online store 106 and/or the relevant user terminal 102ᵢ through the network 104, via the communications interface 142 on the cohort service system 108. However, in some configurations, the cohort service system 108 can communicate directly with the online store 106 and share the cohort information with the online store 106 directly without sending the information through the network 104. Indeed, in some cases, the cohort service system 108 can be a module within the same physical system as the online store 106 or a server in a distributed server system that includes the online store 106, the cohort service system 108, and/or the analytics service system 110. In other embodiments, the cohort service system 108 can be a server separate from the server hosting the online store 106.

In some embodiments, the online store 106 can generate the cohort information for the user terminals 102 without using a separate cohort service system 108. However, the cohort service system 108 can otherwise be implemented in various scenarios. For example, the cohort service system 108 can be implemented in cases where the cohort information is intended to be more detailed and include information that would typically require additional processing time to generate. Thus, the cohort service system 108 can be implemented to lessen the load of generating such cohort information from the online store 106 to avoid the risk of delaying a transaction as a result of processing time spent generating the cohort information.

In this case, the online store 106 can execute the install process while the cohort service system 108 generates the cohort information, and can even finish the install process before the cohort service system 108 has finished generating the cohort information. The user terminals 102 can then query the cohort service system 108 to fetch the cohort information from the cohort service system 108 at a later time. For example, the user terminals 102 can query the cohort service system 108 for the cohort information at one or more intervals, such as every five minutes, until the cohort information is received, a timeout is generated or encountered, the cohort service system 108 returns an error, a number of attempts is exceeded, a threshold period of time is exceeded, or any other event ends the querying and fetching process.

As another example, the cohort service system 108 can be implemented as part of a roll-out schedule to generate cohort information for applications installed on the user terminals 102 that did not receive cohort information at an original installation or purchase event. In this scenario, the cohort service system 108 can be implemented to collect information and generate cohort information for one or more of those apps that did not originally obtain cohort information as part of the installation or purchase process. This way, the processing can be off-loaded from the online store 106 to the cohort service system 108, in order to prevent a delay of transactions between the user terminals 102 and the cohort service system 108 or any performance degradation. In some cases, the cohort information created as part of an initial roll-out process can be limited to a smaller set of cohort information, such as an original purchase date and/or specific store front information. However, this information can be replaced or supplemented as apps are updated or re-downloaded or additional purchase and download events are processed. For example, the roll-out process can initially generate a cohort string containing a purchase date for an app and, when the app is later updated, the cohort string can be replaced to include the date of the update, the date of the purchase, the store front ID, and any other relevant information.

As previously mentioned, the online store 106 can deliver content packages to specific ones of the user terminals 102, including requested Apps and associated cohort information. The user terminals 102 can then install their respective Apps and cohort information as part of the installation process. For example, the user terminals 102 can receive requested Apps from the online store 106 with install metadata that includes respective cohort information. The user terminals 102 can then install the Apps and cohort information for use at the user terminals 102. In some cases, the user terminals 102 can store the cohort information at the operating system level, such as on the kernel space. However, in other embodiments, the user terminals 102 can store the cohort information on user space, as part of the App. Moreover, when storing the cohort information, the user terminals 102 can store the cohort information such that the cohort information is configured to persist. Persistence can be provided based on, for example, the location where the cohort information is stored (e.g., as part of operating system files), the permissions set on the files containing the cohort information, and/or preferences (e.g., one or more plists) set on the user terminals 102 and/or the App instructing the user terminals 102 to keep the cohort information even if the App is removed or otherwise prevent the deletion of the cohort information.

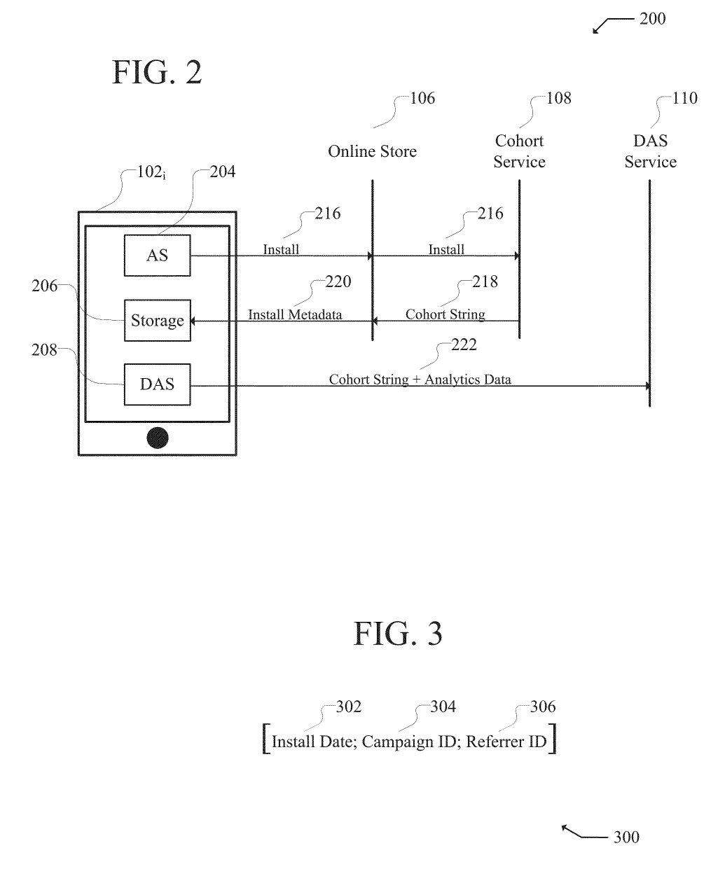

When the cohort information is installed or stored on the user terminals 102, it can be linked or associated with the respective Apps such that the cohort information is attributed to a specific App installed with the cohort information or otherwise received as part of the App or the install process. The user terminals 102 can run a data analytics service (DAS 208 in FIG. 2, below) for monitoring activity on the user terminals 102 relevant to the App installed from the online store 106, and collecting related data analytics, as further described in FIG. 2 below. In some configurations, the data analytics service 208 on user terminals 102 can collect data analytics when an App is launched or executed on the user terminals 102. To this end, the data analytics service 208 on a specific user terminal 102ᵢ can detect a use of an App, such as a launch or execution of the App, and any other activity of the App. This can trigger the data analytics service 208 on the particular user terminal 102ᵢ to collect data analytics of the App. The data analytics service 208 can collect data analytics on a respective user terminal 102, according to any App activity or characteristics of use of the App.

After collecting data analytics for an App, the user terminals 102 can send the cohort information and data analytics to the analytics service system 110. The analytics service system 110 can communicate with the user terminals 102 and receive the cohort information and data analytics via the communications interface 152. Moreover, the analytics service system 110 can store the received information, including the cohort information and data analytics, in the database 150, which can be a local or remote database accessible to the analytics service system 110.

The analytics service system 110 can include an analytics module 150 for analyzing, presenting, storing, modifying, formatting, and collecting the data analytics and cohort information from the user terminals. The analytics module 150 can collect the data analytics and cohort information and generate presentations and interfaces for display to a user, such as a developer. The analytics module 150 can generate views, windows, graphs, displays, images, links, tables, charts, and other content based on the data analytics and cohort information. In some configurations, the analytics module 150 can prepare and condition information, based on the data analytics and cohort information, for presentation at a user interface or a web page. The user interface and the web page can include static and/or dynamic content. Moreover, the user interface and web page can require a user to login to access the information. In some cases, the user interface and web page can be specific to an App or developer, and thus can contain data analytics and cohort information relevant to an App or developer. This way, a developer can login to a page presented by the analytics service system 110 and access the data analytics and cohort information for any particular App associated with that developer.

The analytics module 150 can group, list, categorize, and/or sort data analytics based on cohorts defined in the cohort information. This way, the analytics service system 110 (or a separate device in communications with the analytics service 110) can present data analytics for particular cohorts, which can allow a user such as a developer to view and analyze App metrics for specific cohorts, and even compare metrics for different cohorts to gain insight into the performance and manner of use of a particular App by various cohorts. Cohorts can include any grouping, bucketing, association, partitioning, or segmenting of items, such as users. In some embodiments, a cohort can include a group of users selected or identified based on a particular dimension, attribute, relationship, or characteristic. For example, a cohort can be a group of users that purchased a specific App during a holiday season or on a specific day or event, such as a football championship event. As another example, a cohort can be a bucket of users that were referred by a common referrer when purchasing a particular App. To illustrate, users that were referred by App B to purchase or download App A can be grouped into a cohort of users having in common the referrer App B.

As previously mentioned, the analytics service system 110 can receive the cohort information from the user terminals 110. However, in some embodiments, the analytics service system 110 can also, or alternatively, receive the cohort information from the online store 106 and/or the cohort service system 108. Moreover, in some configurations, the analytics service system 110 can be a server that is separate from the online store 106 and/or the cohort service system 108. However, in other configurations, the analytics service system 110 can be the same server as the online store 106 and/or the cohort service system 108. Further, while the analytics service system 110 can communicate with the online store 106 and cohort service 108 via network 104, in some cases, the analytics service system 110 can communicate directly with the online store 106 and/or cohort service system 108 without going through the network 104.

Referring back to the online store 106, a transactions module 126 can manage, execute, and support any transactions between the online store 106 and the user terminals 102. Here, the transactions can include content downloads, such as App or media downloads; App or media purchases; download requests; purchase requests; view requests; content exchanges; content delivery; content updates; etc. In conducting a transaction, the transactions module 126 can communicate with the content database 130, transactions database 134, user profile database 132, content management module 120, user profile module 122, and/or any other component or module on the online store 106 or a separate device. For example, the transactions module 126 can communicate with the user profile database 132 to retrieve a user profile to associate the transaction with a specific user and/or validate a user, retrieve content from the content database 130 to send to the requesting one of the user terminals 102, and store the conducted transaction in the transactions database 134 to maintain a record, log, or receipt of the transaction. In some cases, the transactions module 126 can also communicate with the cohort module 124 and/or the cohort database 136 in conducting a transaction. For example, as part of an installation of an App on a particular one of the user terminals 102, the transactions module 126 can retrieve a cohort string from the cohort database 136 and send the cohort string to the specific one of the user terminals 102 as part of the installation process.

When sending content to the user terminals 102, the online store 106 can obtain the content from the content database 130, as previously mentioned, but it can also obtain one or more portions of the content (or the whole content) from a separate device. The content can include Apps, text, graphics, audio, video, executable code, or any combination thereof. Further, a content package can include cohort information, such as a cohort string and/or metadata associated with the content. The metadata can include install metadata, descriptive metadata, tags, notes, comments, titles, names, identifiers (IDs), strings, values, etc. In some embodiments, the content can include install metadata that contains the cohort information as a string or identifier.

Furthermore, the content from the online store 106 can be dynamic content. That is, the content can vary over time or can vary based on a user interaction or event. For example, dynamic content can include an interactive game with various levels. However, the various embodiments are not limited in this regard and the content can include static content that neither varies over time nor with user interaction or event. In the various embodiments, content in a content package can be static or dynamic. A content package can include a combination of various types of content in a single content package.

In some cases, a content package can replace or update content in a content package already delivered to a user terminal. For example, a first content package can include an app that can be installed on the user terminal 102ᵢ. A subsequent content package can include a patch or an update to the app. The content update can also include cohort information generated for that update. For example, the content update can install an app update on a previously-installed app and replace or supplement cohort information previously installed for that app. The cohort information can be generated specific to details relating to the update, such as update date, but can also include other information generated since the original cohort information was installed. If the content update is for an app that does not have cohort information already associated with it, the online store 106 can provide an initial set of cohort information as previously described. The content package can also be a re-download of an app or an in-app purchase, such as a new level in a game, for example. Here, the content package can similarly include cohort information to replace previous cohort information for the relevant app, if any. In the case of an in-app purchase, the content package can include cohort information relating to the parent app and/or the purchased content, such as the purchased level, for example.

Although the online store 106, the cohort service 108, and the analytics service 110 are presented herein as separate entities, this is for illustrative purposes only. In some cases, the online store 106, the cohort service 108, and the analytics service 110 can be the same entity. Thus, a single entity can provide all the functionalities of the online store 106, the cohort service 108, and the analytics service 110. Moreover, the use of the cohort service 108 is not required, as previously explained, as the current invention can be practiced without a separate cohort service 108.

If a cohort service system 108 is implemented, the cohort module 124 can request that cohort information be sent directly from the cohort service system 108 to the user terminals 102. For example, the user terminals 102 can fetch the cohort information which can be sent directly from the cohort service system 108 to the user terminals 102 once the cohort information is available and ready. Alternatively, a cached arrangement can also be used to improve performance of the online store 106 and improve overall user experience. That is, the online store 106 can include the cohort database 136 for locally storing/caching cohort information maintained by cohort service system 108. The cohort database 136 can also be implemented in embodiments where the cohort service system 108 is not used, in order to maintain the cohort information that is sent out to the user terminals as part of the installation process.

Additionally, the online store 106 and/or the user terminals 102 can collect user characteristics about a user. In particular, in some cases, one or more of the characteristics of the requesting user(s) can be defined in the cohort information. As used herein, the term “user characteristics” can refer to the characteristics of a particular user associated with one or more of user terminals 102. User characteristics can include app characteristics, device characteristics, demographic characteristics, behavioral characteristics, spatial-temporal characteristics, user attributes, identifying information, user profile information, user activity, a user response to a referral or referrer, user preferences, etc. Spatial-temporal characteristics can define a location, a location zone, a date, a time, or any other characteristic that defines a geographic location and/or a time for delivery or request of the content package. Demographic characteristics can define characteristics of the users receiving the content, such as an app, or associated with the content. For example, demographic characteristics can include age, income, gender, occupation, or any other user characteristics. Behavioral characteristics can define user behaviors for one or more different types or specific items of content, separately or in combination with any other user characteristics. That is, different behavioral characteristics may be associated with different demographic, spatial-temporal, or any other user characteristics. User characteristics can also include characteristics descriptive of a user's activity prior to requesting the content on the online store 106. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the online store 106 can learn of or derive user characteristics from any number of other information sources. For example, in some configurations, the online store 106 can derive or infer one or more user characteristic values from user characteristic values already known about the user.

In some embodiments, a cohort can be associated with one or more characteristics. For example, a cohort can be viewed as defining a space or region in k-dimensional space, where each of the k dimensions is associated with one or more of a plurality of characteristics. In the various embodiments, the k dimensions can include both orthogonal and non-orthogonal dimensions. That is, some of the k dimensions can overlap or can be related in some aspect.

In some embodiments, the online store 106 can include a user profile database 132. The user profile database 132 can, at least in part, be constructed based on declared user characteristics related to one or more users. In some cases, the user profile database 132 may contain inferred or derived user characteristic values. The user profile database 132 can be updated using a user profile module 122. In some embodiments, the user profile module 122 can add additional profile data, update profile data, fill in missing profile data, or infer user characteristic values from declared data.

The user profile module 122 can also be configured to maintain the user profile database 132 to include only more recently acquired data or to re-derive any inferred characteristics in order to ensure that the user profile is an accurate reflection of the current state of the user (location, context, behaviors, demographics, etc.). For example, the user profile module 122 can maintain the user profile database 132 to include only data from the last two to three months. However, the user profile module 122 can adjust the data in the user profile database 132 to cover any span of time. In some instances the user profile module 122 can update the profile database 132 in real-time. Alternatively, the user profile module 122 can set an expiration period on a subset of the data in the user profile database 132. For example, a policy can specify that user declared data is maintained as long as the user account is active, but user characteristic values based on location information expire after a specified period of time. In some cases, a user can set the expiration period. In some instances, the user profile module 122 can update the user profile database 132 at least every week, or every day. In some cases, the online store 106 can receive a direct request to update one or more user profiles. The update request can come directly from the user's device or any other device capable of communicating with the online store 106, such as other content delivery networks or websites. In some cases, the online store 106 can receive an indirect request to update one or more user profiles. An indirect request can be the result of receiving new user characteristic values. An update request can occur at any time.

In the various embodiments, the online store 106 can also include a unique user identifier (UUID) stored as part of a profile in the user profile database 132. The UUID can be used for managing sessions with the various user terminal devices 102. The UUID can be used with a variety of session management techniques. For example, the online store 106 can implement an HTTP cookie or any other conventional session management method (e.g., IP address tracking, URL query strings, hidden form fields, window name tracking, authentication methods, and local shared objects) for user terminals 102 connected to online store 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same UUID. The online store 106 can analyze the attributes of requesting devices to determine whether such requests can be attributed to the same user or device. Such attributes can include device or group-specific attributes.

In some embodiments, the cohort database 136 can be used to aid in describing characteristics and/or groups of users. The cohort database 136 can store defined attributes, characteristics, and associations between the cohorts and users and/or content requested by a user terminal. As described above, a cohort can be defined based on one or more characteristics or derivatives thereof and can be associated with one or more items of content, events, entities, devices, actions, apps, etc. Additionally, a cohort can be associated with multiple users. In some embodiments, by associating a cohort with both a user and an item of content, a user terminal can match content and analytics with users. In some embodiments, the online store 106 can update the cohort database 136 to add newly-defined cohort information, delete previous cohort information, overwrite cohort information, or update cohort information. Moreover, the cohort information in the cohort database 136 can be persisted throughout sessions, events, periods, etc., so the cohort information can be available for future use.

In some cases a cohort can be based on as simple as a single user characteristic identifier and a single user characteristic value. For example, a common install date can be used in defining corresponding cohorts. A characteristic value can also be assigned to the identifier. For example, the values of male, 19, and student can be assigned to the user characteristics of gender, age, and occupation, respectively. However, more complex cohorts can also be defined that consist of one or more identifiers with one or more values associated with each identifier. For example, a cohort can be defined based on one or more of the following characteristics: gender, male; age, 19-24; location, Northern California or New York City; install date, January-February. Additional exemplary cohorts are described throughout this disclosure. Additionally, in some embodiments, user terminals 102 and/or cohort service system 108 can define a custom cohort.

Based on the cohorts identified, the user profile database 132 and cohort database 136 can be updated to reflect the cohorts and cohort information. Additionally, the analytics service system 110 can use the cohorts to present data analytics as previously mentioned.

In some embodiments, the online store 106 can include a content-listing module (not shown). The content-listing module can generate and/or maintain lists of content items, such as apps, that may be purchased or downloaded by a user. The content-listing module can also generate and/or maintain lists of content items and additional information of interest to the user. The items in any particular list generated or maintained by the content-listing module can be updated periodically or based on an event or preference. The items in a list can also be based on a user or device. For example, the content-listing module can generate a specific list of items based on one or more user terminals 102.

The content-listing module can identify and/or select specific items to include in a list of items from one or more master lists of items or databases. For example, the content-listing module can access a database containing all content items and search or filter the content items based on a determined segment to identify and/or select those content items associated with a specific preference or user. The content items in the master list or database can include associations with specific businesses, people, locales, entities, developers, or locations to enable the content-listing module to identify content items having specific associations.

In some configurations, the content items can include metadata defining their respective associations to enable the content-listing module to search and identify content items having specific associations, as previously described. Here, the metadata of the content items can also include additional information which can be used by the content-listing module to search, filter, identify, order, or rank the content items. For example, the metadata can include a respective, unique identifier associated with the content item; the content item's association (e.g., the relationship or association defined for that particular content item); the identity of the content item's associated place or entity; a campaign identifier; a developer identifier; etc. As another example, the metadata can include a tag, a description of the content item or its associated place, a location of the content in storage, a location of the place(s) associated with the content item, a rank of the content item and/or the place associated with the content item, a label, a URL, a preference, an identity, a status, a cohort string, a category, usage information, a configuration, a capability, a playback configuration, etc.

While the online store 106 is presented with specific components, it should be understood by one skilled in the art that the architectural configuration of the online store 106 is simply one possible configuration and that other configurations with more or less components are also possible.

As described above, one aspect of the present technology is the gathering and use of data available from various sources to improve the analytics associated with an app. The present disclosure contemplates that in some instances, this gathered data may include personal information data that uniquely identifies or can be used to contact or locate a specific person. Such personal information data can include demographic data, location-based data, telephone numbers, email addresses, social networking ID's, home addresses, or any other identifying information.

The present disclosure recognizes that the use of such personal information data, in the present technology, can be used to the benefit of users and developers. For example, the personal information data can be used to gain an insight into the interests and habits of the user and optimize content and targeting to this end. Accordingly, use of such personal information data enables calculated control and optimization of the delivered content and campaign. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Moreover, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected, analyzed, and delivered to users by inferring preferences based on non-personal information data or a bare minimum amount of personal information, such as the content being requests by the device associated with a user, other non-personal information available to the content delivery services, or publically available information.

The disclosure now turns to FIG. 2, which illustrates an example system 200 for performing data analytics for a cohort with a cohort service. The user terminal 102ᵢ can include an app store service 204, which includes an app that provides an interface for accessing the online store 106 and interacting with the online store 106. A user at user terminal 102ᵢ can view, download, and purchase items at the online store 106 through the app store service 204.

When the user purchases or downloads an app from the online store 106 through the app store service 204, the app store service 204 can send an install request 216 to the online store 106. The install request 206 can be a message, command, notification, instruction, etc., provided to the online store 106 to inform the online store 106 that a specific app is to be installed on the user terminal 102ᵢ. To this end, the install request 216 can identify the specific app(s) to be installed on the user terminal 102ᵢ. In addition, the install request 216 can include other information, such as a device identifier; user information, such as a user identifier; a campaign identifier; a referrer identifier; preferences; a storage location; installation details; authentication information; etc.

The online store 106 receives the install request 216 and forwards the install request 216 to the cohort service 108. Here, the online store 106 can forward the whole install request 216, a portion of the install request 216, an identifier of the install request 216, or generate a new install request for the cohort service 108. When forwarding the install request 216 to the cohort service 108, the online store 106 can include or add specific information or details to the install request 216. For example, the online store 106 can add a store identifier, a request receipt timestamp, a developer identifier, or any other information to the install request 216 when sending it to the cohort service. In some cases, the online store 106 can add information to the install request 216 inferred or ascertained by the online store 106, which may not have been otherwise included in the install request 216. For example, if the install request does not include an install date, the online store can infer or ascertain the install date based on a date and/or time of the install request 216. To illustrate, if the user terminal 102ᵢ initiates the installation of the app on Aug. 14, 2014, the online store can infer the date Aug. 14, 2014 as the install date. Thus, if the online store 106 wants to add an install date to the install request 216, it can add that date to the install request 216 as the install date. As another example, if the online store 106 receives the install request 216 without a campaign ID, a referrer ID, or any other portion of information, it can query the user terminal 102ᵢ for the missing details and add those details to the install request 216 when it receives them from the user terminal 102ᵢ. In some cases, the online store 106 can also query the user terminal 102, for related information that the online store 106 can use to infer missing information, or otherwise communicate with the user terminal 102ᵢ to extract information from the user terminal 102ᵢ that the online store 106 wishes to include in the install request 216 or can otherwise use to infer missing information.

When forwarded to the cohort service 108, the install request 216 can inform the cohort service 108 that the user terminal 102ᵢ has initiated an app installation and/or sent the install request 216 to the online store 106. This can trigger the cohort service 108 to generate a cohort string 218 and transmit the cohort string 218 to the online store 106 and/or the user terminal 102ᵢ. The cohort string 218 can refer to a string, a value, metadata, a tag, a note, a file, media content, or any other type of content. In other words, while described as a string herein, the cohort string 218 can by any type of content and does not have to be a string.

Moreover, the cohort string 218 can include any characteristic, attribute, or relationship associated with the user, the device, the app being installed, the installation process, the installation request, the online store, and/or any other dimension of information. In some embodiments, the cohort string 218 includes an install date, a referrer identifier, and/or a campaign identifier. For example, referring to FIG. 3, an example cohort string 300 can include an install date 302, a campaign ID 304, and a referrer ID 306. Here, the campaign ID 304 can define information about the campaign associated with the app. The referrer ID can identify the web page, application, window, entity, or device that referred the app being installed to the user installing the app on user terminal 102ᵢ or that prompted or caused the user to initiate an installation of the app.

Referring back to FIG. 2, the online store 106 can receive the cohort string 218 from the cohort service 108 and send install metadata 220 to the user terminal 102ᵢ. Alternatively, the online store 106 can send the cohort string 218 itself, or any portion of the cohort string 218, to the user terminal 102ᵢ.

The install metadata 220 can include the cohort information in the cohort string 218, or any portion of the cohort information in the cohort string 218. In some embodiments, the install metadata 220 includes the cohort string 218, as well as installation information associated with the app and/or the installation process. The install metadata 220 can also include store information, instructions, download information, and/or purchase information. Moreover, the online store 106 can send the install metadata 220 to the user terminal 102ᵢ with the app, as part of the app, or as part of the installation process.

The user terminal 102; receives the install metadata 220 and can use the install metadata 220 to install the app and the cohort information from the cohort string 218. In some embodiments, the user terminal 102ᵢ receives the install metadata 220 and stores the install metadata 220 on storage 206. In other embodiments, the user terminal 102ᵢ receives the install metadata 220, extracts any cohort information in the install metadata 220, and stores the cohort information on storage 206. For example, the user terminal 102ᵢ can receive the install metadata 220, extract the cohort string 218 from the install metadata 220, and store the cohort string 218, or any portion of the cohort string 218, on storage 206. Storage 206 can be any memory or non-transitory storage medium on the user terminal 102ᵢ. Moreover, storage 206 can include a storage device storing apps installed on the user terminal 102ᵢ and/or an operating system of the user terminal 102ᵢ.

When storing the cohort information, the user terminal 102ᵢ can link or associate the cohort information to the app and/or installation process. For example, the user terminal 102ᵢ can augment the cohort information to include, or map the cohort information to, an identifier of the app, the purchase or download of the app, an installation ID, a store ID, and so forth. The user terminal 102ᵢ can map the cohort information by including a reference on a table, database, list, preference, configuration file, registry, etc. The reference can identify any portion of the cohort information, as well as the linked information, such as the app ID, the purchase or transaction ID, the store ID, etc.

Furthermore, the user terminal 102ᵢ can store the cohort information as part of the operating system and/or as part of the application. For example, the user terminal 102, can install an instance of the cohort information in kernel space. Alternatively, or in addition, the user terminal 102ᵢ can store the cohort information in user space, such as in a folder or application area associated with the app. In addition, when storing the cohort information, the user terminal 102ᵢ can configure the cohort information to persist on the storage 206. For example, the user terminal 102ᵢ can configure the cohort information to persist from the install all the way through the collection of data analytics. In some cases, the user terminal 102ᵢ can even configure the cohort information to persist even after the app is deleted or removed from the user terminal 102ᵢ. Thus, if the app is removed and later re-installed on the user terminal 102ᵢ the cohort can persist and can be used with the app after being re-installed.

The user terminal 102ᵢ can ensure the cohort information persists based on a storage location, such as a protected location; permission rules or preferences, such as file or folder permissions; policies, such as device or domain policies; and/or persistence preferences, such as a preference file or instruction which tells the user terminal 102ᵢ to persist the cohort information and protect that information from deletion. For example, the user terminal 102ᵢ can ensure the cohort information persists by installing or storing the cohort information at an operating system level; by placing a tag, attribute, or preference on the file or folder storing the cohort information that causes the information, file, and/or folder to persist; by setting read, write, delete, or modify permissions to forbid deletion or modification of the information; and/or by setting a preference on the operating system or the user terminal 102ᵢ to persist the information.

The user terminal 102ᵢ can run a data analytics service 208. In some configurations, the data analytics service 208 can run in the background as a background service and monitor activity of the app installed from the online store 106. The data analytics service 208 can detect a launch or execution of the app, and any other activity. When the data analytics service 208 detects that the app has been launched or executed on the user terminal 102ᵢ the data analytics service 208 can monitor, collect, store, and/or analyze any activity, statistics, and data analytics associated with the app. For example, when a user at the user terminal 102ᵢ launches the app on the user terminal 102ᵢ the data analytics service 208 can detect that the app has been launched and begin to collect data analytics for the app based on any activity performed by the app or associated with the app. The data analytics service 208 can log and collect the data analytics, store the data analytics, filter the data analytics, modify the data analytics, arrange the data analytics, forward the data analytics, analyze the data analytics, etc.

The data analytics service 208 can also collect data about the app when the app is not running or that is based on periods of time when the app has not executed. For example, if the app is installed and never executed or launched thereafter, the data analytics service 208 can determine that the app was installed at a particular date and never launched since. The data analytics service 208 can then generate data analytics specifying the lack or absence of activity associated with the app, as well as the install date. This way, the data analytics can inform a user analyzing the data that the app was installed on the user terminal 102ᵢ on a specific date and never used since then. This information can provide advantageous insight about a particular cohort of users. For example, a developer can review the app activity for a cohort made up of users that installed the app on Aug. 14, 2014. The app activity would, in this example, suggest to the developer that the app was never executed or launched at the user terminal 102; since it was installed. The developer can then infer certain information from such statistics. For example, if Aug. 14, 2014 was a date were the app was provided for free as part of a campaign or promotion, the developer would be able to infer that some users in that cohort installed the app because it was provided for free, but never actually used the app and perhaps were never truly interested in the app. As another example, if Aug. 14, 2014 was a date when the app was updated to a new version with added features, the developer may be able to infer that new users, including users who installed the app after the app was updated/augmented, did not like or enjoy the new version of the app.

The data analytics can thus include information obtained based on an activity or use of the app, but can also obtain information obtained, determined, or inferred based on a lack or absence of activity or use. In addition, the data analytics can also include information generated by the user terminal 102ᵢ and/or received from a user. For example, the app or data analytics service 208 can collect feedback from the user at the user terminal 102ᵢ and include the feedback as part of the data analytics. As another example, the data analytics service 208 can detect any inputs, such as gestures or commands, from the user at the user terminal 102ᵢ during an execution of the app and collect the inputs as part of the data analytics, or otherwise analyze the inputs to generate data based on, or descriptive of, the inputs. In some cases, the data analytics service 208 can also gather data about other apps or services running on the user terminal 102ᵢ when the app is also running, and associate or link that data with the data analytics gathered from the activity at the app, to provide a more complete picture of the user activity or context. Here, the data analytics service 208 can analyze the data gathered from the other apps or services and determine a relevance, relationship, or significance of that data with respect to the data analytics associated with the app, and prepare or condition that data, or portion(s) of that data, for inclusion into the data analytics gathered for the app.

Once the data analytics service 208 collects data analytics, it can report the data analytics to the analytics service system 110. Here, the data analytics service 208 can transmit the cohort string and analytics data 222 to the analytics service system 110 for presentation, analysis, conditioning, storing, etc., at the data analytics service system 110. In some configurations, the data analytics service 208 can transmit the data 222 to the analytics service system 110 on a continuing basis, for example, as the information is collected or generated by the data analytics service 208. In this regard, the data analytics service 208 can send the data 222 and any updates as they are created or obtained, or on a particular schedule, such as once a day. In other configurations, the data analytics service 208 can transmit the data 222 only as the collection process is finished, when a session at the user terminal 102ᵢ when the app is terminated at the user terminal 102ᵢ and the app session is complete, or in response to any event, such as a request or a command, for example.

The analytics service system 110 can receive the data 222 and collect and store the analytics data and cohort information for presentation to a user, such as a developer. Using the cohort information, the analytics service system 110 can group, categorize, sort, segment, or partition analytics data for one or more specific cohorts defined by the cohort information. The data analytics service system 110 can receive analytics data and cohort information from multiple devices for any specific app and associate the complete set of data by app and/or cohort. This way, a developer can access analytics data for a particular app from the developer, and view the analytics data by cohort. Accordingly, the developer can obtain metrics about the app for particular cohorts, and even compare the metrics between the cohorts.

The data analytics service system 110 can report any portion of analytics data or cohort information received from a user terminal. For example, a developer can set a preference at the data analytics service system 110 to receive a notification when the analytics data collected by the data analytics service system 110 indicates a particular condition, such as a lack of use, defined in the preferences. The data analytics service system 110 can then send a notification to the developer when the condition occurs. In addition, the data analytics service 110 can condition the data received from a user terminal, including the analytics data and/or the cohort information, and prepare the data for presentation through a web page or a user interface, for example. The analytics data can be grouped or categorized based on the cohort information, as well as formatted in a chart, graph, image, table, etc. The analytics data can also be sorted, ranked, tagged, or otherwise manipulated for presentation to a user.

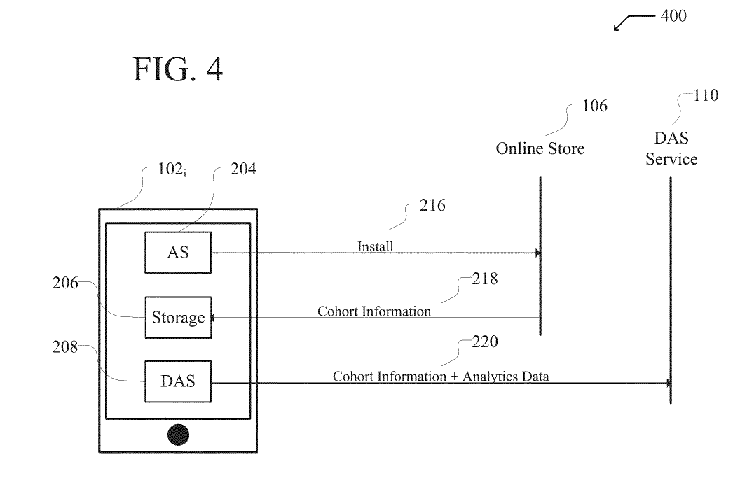

The disclosure now turns to FIG. 4, which illustrates an example system 400 for performing data analytics without a cohort service. The app service 204 on the user terminal 102ᵢ can receive a user request to install an app on the online store 106, and subsequently initiate a transaction with the online store 106. Here, the user terminal 102, sends an install message 216 to the online store 106 to initiate the install of the app. The online store 106 can then generate cohort information 218 as part of transaction, and send the cohort information 218 to the user terminal 102ᵢ as part of the install process. The online store 106 can generate the cohort information based on, for example, the purchase or transaction details, the install or request date, the store front ID, the device ID, and any other piece of information, including information contained in the install request 216. For example, in some cases, the install request 216 can include a referrer or domain ID, a campaign ID, a version ID, etc. Here, the online store 106 can analyze the install request 216 and extract one of the information in the install request 216, such as the referrer ID, and include the information in the cohort information 218.

The cohort information 218 can be persisted on the online store 106, as well as the storage 206 on the user terminal 102ᵢ The cohort information can be persisted to allow that information to be used or referenced at a later time. For example, if the install request is a re-download request, the cohort information from the original download or purchase can be obtained from the online store 106, as it can be persisted on the online store 106 from the moment it is originally created.

The user terminal 102ᵢ receives the cohort information 218 and stores it on storage 206 on the user terminal 102ᵢ, as previously explained. If the storage 206 contains previously-generated cohort information for the specific app, the cohort information 218 can overwrite or replace the previously-generated cohort information. For example, if the install is an update or re-download of an app that already has cohort information, the new cohort information can be used to overwrite or replace the previous cohort information. However, in some embodiments, the cohort information 218 can supplement the previously-generated cohort information. For example, the user terminal 102ᵢ can compare the cohort information 218 with the previously-generated cohort information to reconcile any differences.

Moreover, if the install is an in-app install, the cohort information can include cohort information about the in-app install as well as cohort information about the parent. For example, if the parent app includes cohort information defining a specific referrer ID for the parent app and an install or purchase date for the parent app, the cohort information 218 for the in-app purchase can include the install date stemming from the in-app purchase, the referrer ID of the parent app, and/or the install or purchase date for the parent app. This way, the cohort information for the parent app and the in-app purchase can be tied together.

The data analytics service 208 on the user terminal 102ᵢ can then monitor user behavior, such as app usage events, and collect analytics data relevant to the app in order to report that data to the analytics service system 110. Thus, when the data analytics service 208 on the user terminal 102ᵢ collects analytics data, it can send the cohort information and analytics data 220 together to the analytics service system 110 for collection and presentation at the analytics service system 110, as previously described. When the analytics service system 110 reports analytics data, it can include app session data, store cohort data, as well as any additional information. The cohort data can allow the analytics service system 110 to track user behavior and app data based on cohort characteristics without the use of real, private user information, to protect the privacy of the user's information, such as the user's real name.

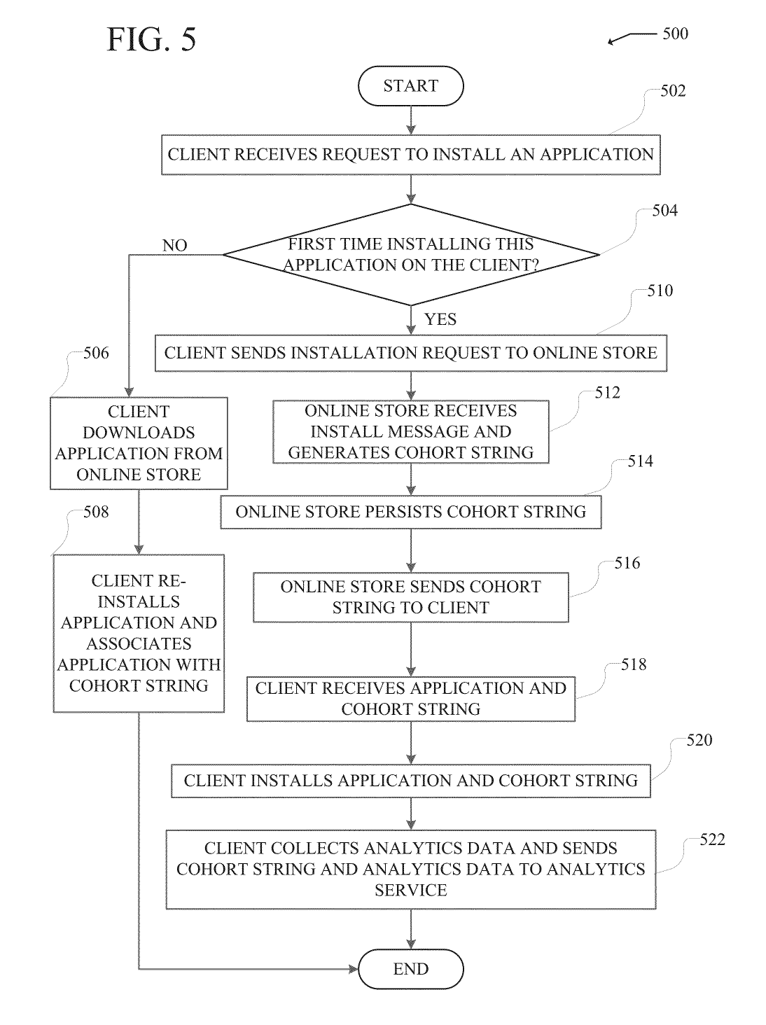

Having disclosed some basic system components and concepts, the disclosure now turns to the example flowchart embodiment shown in FIG. 5. For the sake of clarity, the flowchart is described in terms of an online store 106 and an analytics service system 110, as shown in FIG. 1, as well as a user terminal 102ᵢ, as shown in FIG. 2, all configured to practice the steps in the flowchart. The steps outlined herein are exemplary and can be implemented in any combination thereof, including combinations that exclude, add, or modify certain steps.

At step 502, the user terminal 102ᵢ first receives a request to install an application. The request can be received from a user after a user selection of the application from the user terminal 102ᵢ. The user selection can be provided by a user through an application on the user terminal 102ᵢ, which can conduct transactions, such as purchases and downloads, from the online store 106. For example, the user can launch the app store service 204, illustrated in FIG. 2, and select the application for installation from the app store service 204 to initiate the installation process.

At step 504, the user terminal 102ᵢ determines if this application has been previously installed on the device. If the application has been previously installed on the device, at step 506, the user terminal 102ᵢ downloads the application from the online store 106. At step 508, the user terminal 102ᵢ then re-installs the application and associates cohort information with the application. The cohort information can be stored on the user terminal 102ᵢ from the online store 106, which generated the cohort information as further described below. The cohort information can overwrite or replace the previous cohort information but, in some cases, it can alternatively supplement the previous cohort information.

At step 510, if this application was not previously installed, the user terminal 102, then sends an installation request to the online store 106. For example, the app store service 204 on the user terminal 102ᵢ can receive the installation request from the user and send or forward the request to the online store 106. The installation request can include additional information, such as a campaign ID associated with the install request, a referrer ID, a date, a store front ID, a version ID, etc. For example, such information can be included through a URL or a conventional HTTP cookie mechanism. The online store 106 can then extract any portion of this information when generating the cohort information as later described.

Next, the online store 106 can send an install message to the cohort service system 108 to trigger the cohort service system 108 to generate cohort information for the installation. The install message here can alert the cohort service system 108 that cohort information needs to be generated for the installation. Moreover, the install message can be any command, instruction, notification, or message for triggering the cohort service system 108 to generate cohort information. In addition, the install message can include information which can be used by the cohort service system 108 to generate the cohort information. For example, the install message can include an app ID, an app description or title, a store ID, a device ID, an install date, a referrer ID, a campaign ID or description, a transaction ID, user characteristics, a timestamp, etc.

In some configurations where the cohort service system 108 is implemented to generate the cohort information, the user terminal 102ᵢ can be configured to fetch the cohort information from the cohort service system 108. For example, the user terminal 102ᵢ can contact the cohort service system 108 at one or more times or intervals to obtain the cohort information when the cohort service system 108 has the information available.

At step 512, the online store 106 receives the install message from the user terminal 102ᵢ and generates a cohort string. While described herein as a cohort string, the cohort information is not limited to a string. Other formats, types, and content are contemplated herein such as a file, an image, a tag, metadata, or any other type of content. However, for illustration purposes and the sake of simplicity, the cohort information is described here as a cohort string. The cohort string can be generated based on information extracted from the install message, such as buy parameters, referrer ID, campaign ID, etc., as well as information generated for the transaction, such as purchase information.

At step 514, the online store 106 persists the cohort string at the online store 106. In some embodiments, the online store 106 can store the cohort string on a storage or database associated with the online store 106. In other embodiments, the online store 106 can persist the cohort string at a key/value store at the online store 106, which, in some cases, can provide faster performance and access times. In still other embodiments, the online store 106 can persist the cohort string on both a database and a key/value store. Here, the key/value store can be accessed to retrieve the cohort string during an install process without delaying the installation or purchase through the cohort retrieval. By persisting the cohort string, the online store 106 can provide the information to a user terminal at a future time, such as a re-download. For example, in a re-download, the user terminal can fetch the cohort string from the online store 106 to re-install the cohort string with the re-download.

At step 516, the online store 106 sends the cohort string and application to the user terminal 102ᵢ. The online store 106 can send the cohort string as part of the application for installation at the user terminal 102ᵢ of both the cohort string and the application. In some cases, the online store 106 can combine the cohort string and application into a package and send the package to the user terminal 102ᵢ. For example, the online store 106 can include the cohort string as install metadata included with the application. This way, the user terminal 102ᵢ can receive the application and install the application and cohort string using the install metadata. In other cases, the online store 106 can send the cohort string and application separately to the user terminal 102ᵢ. For example, the online store 106 can send the application as one file, package, or stream, and the cohort string as a different file, package, or stream. In still other cases, the online store 106 can send only the application to the user terminal 102ᵢ and the user terminal 102ᵢ can then fetch the cohort string from the online store 106 as necessary.

At step 518, the user terminal 102ᵢ receives the application and cohort string. At step 520, the user terminal 102ᵢ then installs the application and cohort string. Here, the user terminal 102ᵢ can store the cohort string as part of the application, as part of the operating system, or both. In some embodiments, when storing the cohort string, the user terminal 102ᵢ can ensure that the cohort string persists even after the application is removed from the user terminal 102ᵢ. For example, the user terminal 102ᵢ can set specific policies, rules, and/or restrictions to prevent the cohort string from being removed and/or edited. In other embodiments, the cohort string can be overwritten when the application is updated and/or re-downloaded.

At step 522, the user terminal 102ᵢ collects analytics data and sends the cohort string and analytics data to the analytics service system 110. In some embodiments, the user terminal 102ᵢ collection of analytics data by the user terminal 102ᵢ can be triggered by a detection of use of the application on the user terminal 102ᵢ. For example, when the application is launched or executed, the user terminal 102ᵢ can begin collecting analytics data at the user terminal 102ᵢ. The analytics data can be based on a user and application activity at the user terminal 102ᵢ. In some embodiments, the analytics data can also include information or statistics relating to other services or applications on the user terminal 102ᵢ. For example, the analytics data can include information defining what other services or applications are used by the user or application during the monitored activity.

The analytics service system 110 can receive the cohort string and analytics data and store, present, or manipulate the information in any way to provide access to the information for a user, such as a developer. The analytics service system 110 can receive and collect analytics data from various devices in an on-going basis, updating the stored information as it receives new information.

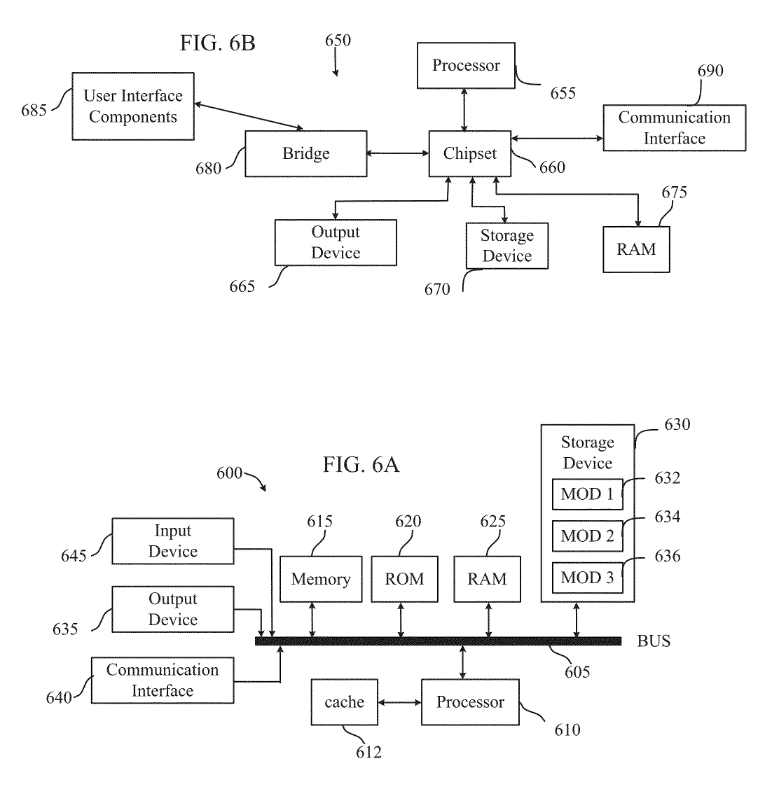

FIG. 6A, and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

We claim:

1. A computer-implemented method comprising:
sending, from a device to a server, a request to install on the device an application from the server;
receiving, at the device, a cohort string generated based on the request, the cohort string being received as installation data associated with the application;
installing the cohort string at the device, the cohort string being linked to the application on the device as part of an installation of the application on the device;
detecting a use of the application at the device;
based on the use detected at the device, collecting analytics data about the use of the application at the device; and
sending the cohort string and the analytics data to a data analytics service.

2. The computer-implemented method of claim 1, wherein the cohort string is configured to persist on the device after at least one of a removal of the application from the device or a re-installation of the application on the device, the method further comprising:
uninstalling the application from the device; and
persisting the cohort string on the device after the application has been uninstalled from the device.

3. The computer-implemented method of claim 2, further comprising:
reinstalling the application on the device; and
after reinstalling the application on the device, relinking the cohort string to the application on the device.

4. The computer-implemented method of claim 1, wherein the analytics data is collected further based on the cohort string, and wherein the cohort string is installed or updated during the installation of the application on the device.

5. The computer-implemented method of claim 1, further comprising detecting an execution of the application, wherein collecting the analytics data is triggered by the execution of the application.

6. The computer-implemented method of claim 1, wherein the cohort string is received as install metadata associated with the application, and wherein the cohort string defines at least one of an install date, a campaign identifier, and a referrer identifier.

7. The computer-implemented method of claim 1, wherein the server comprises at least one of an online store or a cohort service associated with an online store, and wherein the cohort string further comprises at least one of user data, install data, device data, or online store data.

8. The computer-implemented method of claim 1, wherein the cohort string is installed on the device as part of at least one of an operating system on the device or the application.

9. The computer-implemented method of claim 1, further comprising sending, from the device to the server, installation information as part of the request, wherein the cohort string is installed automatically on the device during the installation of the application, and wherein the cohort string is generated based on the installation information.

10. The computer-implemented method of claim 1, wherein installing the cohort string is performed without a particular software development kit.

11. The computer-implemented method of claim 1, wherein the device comprises a client device, and wherein the cohort string and the analytics data are sent by the client device to a data analytics server running the data analytics service.

12. The computer-implemented method of claim 1, wherein the analytics data comprises statistics associated with an attribute defined in the cohort string, the statistics comprising application usage information.

13. The computer-implemented method of claim 1, further comprising:
sending, to the server, an update request associated with the application on the device;
receiving, at the device, an application update and an updated cohort string; and
installing the application update and the updated cohort string at the device.

14. A system comprising:
a processor;
a computer-readable storage medium having stored therein instructions which, when executed by the processor, cause the processor to perform operations comprising:
transmitting, from the system to a server, a request to install on the device an application from the server;
receiving, at the system, cohort data received as installation data associated with the application, the cohort data being received from the server in response to the request to install the application;
storing the cohort data at the system, the cohort data being linked to the application on the system;
detecting a user of the application at the system;
based on the use of the application at the system, collecting usage data about the application at the system; and
transmitting, by the system, the cohort data and the usage data to a data analytics service.

15. The system of claim 14, wherein the cohort data is configured to persist on the system after at least one of a removal of the application from the system and a re-installation of the application on the system, and wherein the computer-readable storage medium stores additional instructions which, when executed by the processor, result in operations further comprising:
uninstalling the application from the system; and
persisting the cohort data on the system after the application has been uninstalled from the system.

16. The system of claim 15, wherein the computer-readable storage medium stores additional instructions which, when executed by the processor, result in operations further comprising:
reinstalling the application on the system; and
associating the cohort data with the application on the system after the application has been reinstalled.

17. The system of claim 14, wherein the cohort data is received by the system as install metadata associated with the application, and wherein the cohort data defines at least one of an install date, a campaign identifier, or a referrer identifier.

18. The system of claim 14, wherein storing the cohort data comprises installing the cohort data on the system at an operating system level or during an installation of the application as part of the application, and wherein the usage data comprises statistics associated with at least one cohort characteristic defined by the cohort data.

19. A non-transitory computer-readable storage medium having stored therein instructions which, when executed by a processor, cause the processor to perform operations comprising:
sending, from a device to a server, a request to install on the device an application from the server;
receiving, at the device, a cohort identifier received as installation data associated with the application;
installing the cohort identifier at the device, the cohort identifier being associated with the application on the device;
detecting a user of the application at the device;
based on the use of the application at the device, collecting analytics data about the use of the application at the device; and
sending the cohort identifier and the analytics data to a data analytics service.

20. The non-transitory computer-readable storage medium of claim 19, storing additional instructions which, when executed by the processor, perform operations further comprising:
deleting the application from the device;
persisting the application at the device after the application has been deleted;
reinstalling the application at the device; and
reassociating the cohort identifier with the application after the application has been reinstalled at the device.

21. The non-transitory computer-readable storage medium of claim 19, wherein the cohort identifier defines at least one of an install date, a campaign identifier, or a referrer identifier, and wherein the cohort identifier is installed on the device at an operating system level or as part of the application and without a particular software development kit.

22. The non-transitory computer-readable storage medium of claim 19, wherein the request to install the application comprises a reinstall request, the application having been previously installed and removed from the device prior to the reinstall request, wherein installing the cohort identifier comprises overwriting a previously-installed cohort identifier associated with a previous installation of the application with the cohort identifier.

23. A method comprising:
receiving, via a server, an installation request from a device, the installation request being configured to trigger an installation of a selected application and associated cohort information;
generating the associated cohort information based on the installation request, the associated cohort information defining at least one of an installation date, a campaign identifier, or a referrer identifier; and
sending the associated cohort information for installation at the device in association with an installation of the selected application specified in the installation request, wherein the associated cohort information is sent as install metadata associated with the selected application for installation at the device without a software development kit.

24. The method of claim 23, wherein the server comprises an online store and the device comprises a client device, and wherein the cohort information defines at least one of an install date, a campaign identifier, or a referrer identifier.

25. The method of claim 23, wherein the server comprises a cohort service, and wherein the installation request is received by the cohort service from an online store associated with the selected application.
